(19) United States
(12) Patent Application Publication
(10) Pub. No.: US 2018/0000040 A1
(43) Pub. Date: Jan. 4, 2018

(54) Apparatus for Raising Hatchlings Including a Paper Strip

(71) Applicant: Andrew Maendel, Starbuck (CA)

(72) Inventor: Andrew Maendel, Starbuck (CA)

(21) Appl. No.: 15/201,562

(22) Filed: Jul. 4, 2016

(51) Int. Cl. A01K 1/015; A01K 31/18; A01K 39/01; A01K 39/02

(52) U.S. Cl. CPC A01K 1/015; A01K 39/0213; A01K 31/18; A01K 39/01

(57) ABSTRACT

In an apparatus for raising chickens from hatchlings including a barn having a floor and walls there is provided a plurality of rows of feed stations arranged at spaced positions across the floor each with a feed supply line connected along the row for dispensing feed to each of the feed stations and a plurality of rows of water supply stations each with a water supply line connected along the row for dispensing water to each of the water supply stations where rows of stations are connected to a lift system for raising the stations from the floor. A first strip of biodegradable paper sheet is unrolled along the floor of the barn underneath the row of feed stations and a second strip of biodegradable paper sheet unrolled along the floor of the barn underneath the row of water supply stations where the biodegradable paper is colored with a color selected to be attractive to hatchlings, typically red.

This invention relates to a paper strip for use in raising hatchlings.

### BACKGROUND OF THE INVENTION

In U.S. Pat. No. 5,526,759 issued Jun. 18, 1996 by Cox is disclosed an apparatus for laying chick feed support paper. Such paper is used to provide a protective layer on the floor of a containment pen on which the hatchlings are placed when supplied to the pen to grow into larger birds. It is known that placing the hatchlings or chicks on paper strip with feed immediately accessible to them reduces mortality and encourages growth.

Traditionally such paper strip is laid manually by unrolling from a roll and a strip of feed material is poured or placed on the strip before the chicks are manually carried in to the pen and deposited on the paper with the feed.

Cox provides a trailer arrangement which carries a roll of the paper strip, in which a groove is formed in the material, such as straw or wood shavings, forming the floor surface and the paper is laid into the groove by a rolling wheel which holds the strip in place as it is unrolled from a supply. This device has apparently found little commercial success and is believed not to be available on the market place.

A product named FEED CADDY as shown in U.S. Pat. No. 6,857,390 (Maendel) issued Feb. 22, 2005 includes an apparatus comprising a vehicle for movement over a floor of a containment area for raising hatchlings into birds, a support on the vehicle for receiving a roll of a sheet material such that the roll can dispense the sheet material as a strip laid onto the floor as the vehicle is moved across the floor, a hopper on the vehicle for receiving a feed material for the hatchlings, and a dispensing nozzle of the hopper arranged for dispensing a layer of the feed material onto the strip after the strip is laid as the vehicle is moved forwardly.

In this way the paper strips are laid on the floor and the hatchlings and the feed protected from the floor with the feed readily available to the hatchlings until they are old and mature enough to properly access feed and water stations provided on the floor.

### SUMMARY OF THE INVENTION

It is one object of the invention to provide an improved apparatus for use in rearing hatchlings in the time period immediately after hatching.

According to one aspect of the invention there is provided an apparatus for raising chickens from hatchlings to a larger size comprising:

a roll of biodegradable paper sheet for laying along the floor of a barn onto which the hatchlings are placed arranged for raising the chickens from the hatchlings to a larger size;

wherein the biodegradable paper is colored with a color selected to be attractive to hatchlings.

Preferably the paper is colored red. However in some cases other colors are attractive to the hatchlings including colors sufficiently close to red to provide the attraction to the hatchlings.

According to a second aspect of the invention there is provided an apparatus for raising chickens from hatchlings to a larger size comprising:

a barn having a floor and walls for containing the hatchlings;

a plurality of feed stations arranged at spaced positions across the floor;

a plurality of water dispensing stations arranged at spaced positions across the floor;

and a roll of biodegradable paper sheet unrolled along the floor of the barn onto which the hatchlings are placed arranged for raising the chickens from the hatchlings to a larger size;

wherein the biodegradable paper is colored with a color selected to be attractive to hatchlings.

In some cases the paper forms a strip located between the feed stations and the water supply stations which are arranged in parallel rows.

According to a third aspect of the invention there is provided an apparatus for raising chickens from hatchlings to a larger size comprising:

a barn having a floor and walls for containing the hatchlings;

a row of feed stations arranged at spaced positions across the floor with a feed supply line connected along the row for dispensing feed to each of the feed stations;

the row of feed stations being connected to a lift system for raising the feed stations from the floor;

a row of water supply stations arranged at spaced positions across the floor with a water supply line connected along the row for dispensing water to each of the water supply stations;

the row of water supply stations being connected to a lift system for raising the water supply stations from the floor;

a first strip of biodegradable paper sheet unrolled along the floor of the barn underneath the row of feed stations;

and a second strip of biodegradable paper sheet unrolled along the floor of the barn underneath the row of water supply stations;

wherein the biodegradable paper is colored with a color selected to be attractive to hatchlings.

In order to best supply the hatchlings before they can properly access feed dishes, preferably the row of feed stations includes a plurality of feed supply dishes into which feed is deposited from the feed supply line and in addition there is provided a plurality of feed drops where the feed is deposited directly onto the strip of paper. These can be shut off when the hatchlings are old and mature enough to always access the feed in the dishes.

Preferably the feed drops of the row of feed stations are located intermediate the feed supply dishes.

Preferably the row of water supply stations are arranged such that the water is deposited directly onto the strip of paper.

### BRIEF DESCRIPTION OF THE DRAWINGS

One embodiment of the invention will now be described in conjunction with the accompanying drawings in which:

FIG. 1 is a side elevational view of a prior art apparatus for dispensing a paper layer for raising hatchlings.

FIG. 2 is a top plan view of the apparatus of FIG. 1.

FIG. 3 is a longitudinal cross-sectional view of a barn showing the strip laid on the floor underneath a row of feeders.

FIG. 4 is a transverse cross-sectional view of a barn showing the strip laid on the floor underneath a row of feeders and a row of water nipples.

### DETAILED DESCRIPTION

In the figures is shown an apparatus for laying a strip of sheet material 10 from a roll 11 and for depositing upon the strip 10 a layer 12 of a particulate feed material for hatchlings or chicks 13. The strip 10 is laid flat upon a floor 14 of a containment pen, the floor being formed of suitable materials well known to one killed in the art for raising birds from hatchlings.

The apparatus comprises a trailer 15 including a frame 16 and ground heels 17. The frame 16 includes frame members arranged to support a hopper 17 carried on the frame. The arrangement of the frame members will be well known to one skilled in the art so that detailed description is not required. The hopper 17 includes vertical side walls and inclined hopper bottom walls 19 and 20. The frame provides a hitch 21 at the forward end for attachment to a suitable tractor 22.

The frame 16 carries a pair of forwardly extending support walls 23 and 24 which extend forwardly from the front of the support legs 25 of the hopper. The side wall 23 and 24 are spaced by a width equal to the width of the roll 11 so that the roll is supported between the side walls on a support shaft 27. The roll is thus supported on the front of the hopper between the hopper and the tractor at a position spaced upwardly from the floor. The frame defines frame members which are spaced apart by a width greater than the width of the strip on the roll 11 so that the strip is free to fall downwardly between the frame members and between the wheels to lie upon the floor 14.

The strip is preferably formed of a biodegradable paper material which can be laid over the floor to provide a smooth support surface for receiving the feed and the hatchlings. The sheet material is of a nature which protects the hatchlings from the rough floor and supports the feed so that it is protected against being lost within the floor surface. Thus the hatchlings can be placed upon the paper or other sheet material and supported thereon in a manner which provides immediate access to the feed around them on the paper.

The hopper 17 has the side walls 19 converging inwardly and downwardly to the ends of a bottom nozzle or slot 30 extending across the width of the apparatus. The rolls 20 also converge inwardly and downwardly to define sides 31 of the nozzle.

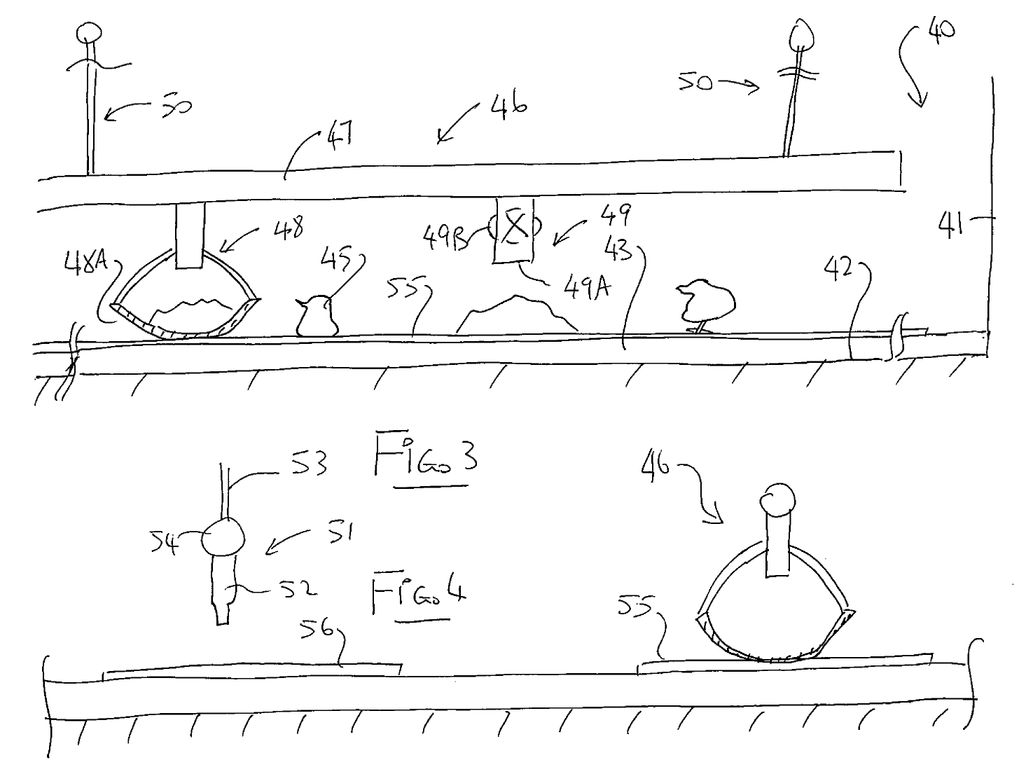

The width of the nozzle 30 is arranged to be slightly less than the width of the sheet material. Thus as shown in FIG. 3, the layer 12 falls from the nozzle 30 onto the sheet 10 and defines ends 12A of the layer 12 which are spaced inwardly from side edges 10A of the strip material leaving a narrow band of the strip material which is free from the layer.

As the nozzle has a constant width across its full length, the layer that is discharged from the hopper is of a constant thickness, provided that the vehicle is moved across the floor at a constant speed.

Thus the arrangement has the advantage that the layer of feed material can be spread evenly across the sheet as close as possible to the edges without risk of losing feed material over the edges so that there are no bare patches on the sheet and no piles of excess feed on the sheet.

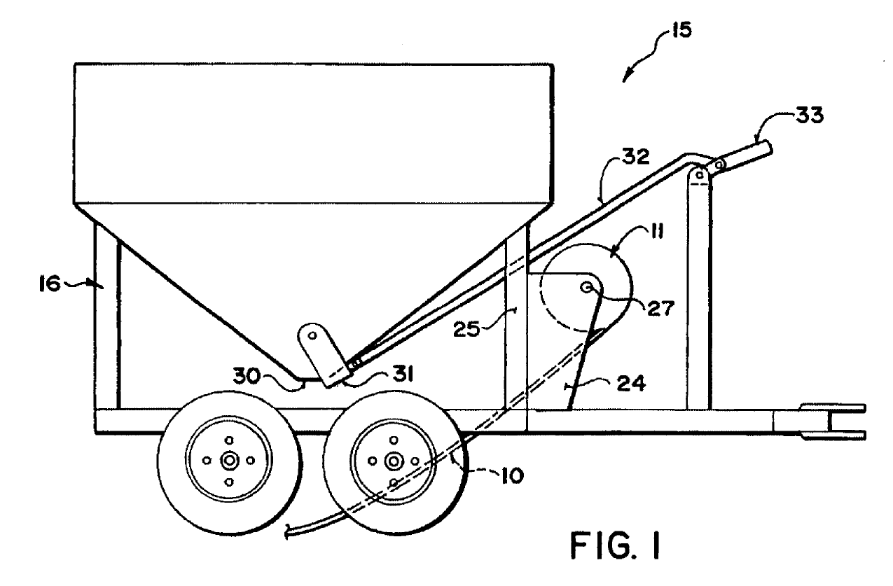

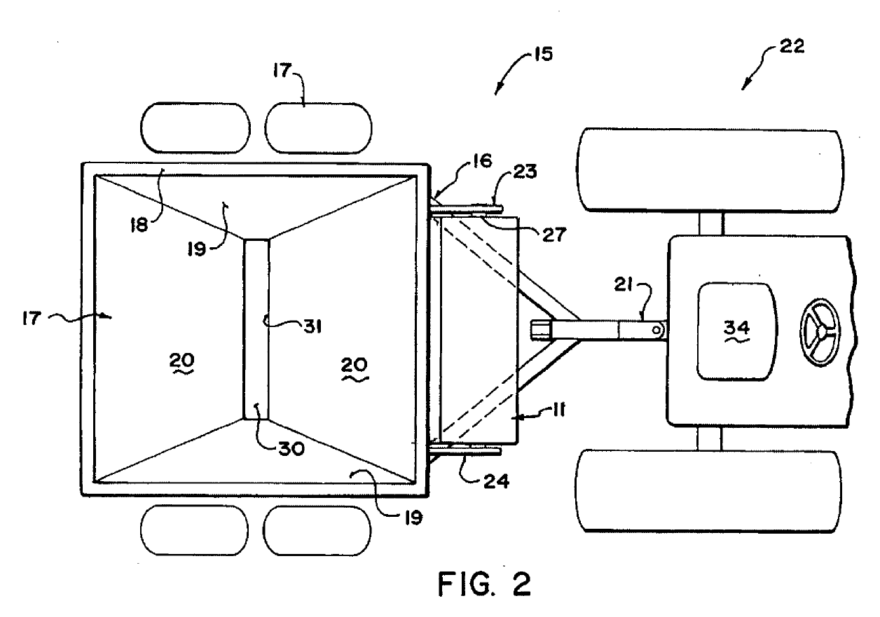

The rate of feed through the nozzle can be controlled by a closure plate 31 shown best in FIG. 1 which is operated by a link 32 movable by a lever 33 operable by an operator seated on a seat 34 of the tractor 22. Thus depending upon the flowability of the feed material in particulate form but in the hopper and depending upon the speed of movement across the floor, the operator can move the closure plate 31 to a required position to adjust the width of the slot. The closure plate is located underneath the slot or nozzle 30 so that it can be moved wholly out of the way of the nozzle allowing the full width of the nozzle to discharge the feed material or it can be moved to a position fully closing the nozzle to close off feed when not required or it can be moved to an intermediate position thus adjusting the width of the nozzle 30.

In operation, the operator grasps a portion of the strip material and pulls it underneath the hopper from the roll 11 so that the strip material is located on the floor behind the trailer 15. With the strip material so in place, the operator opens the nozzle 30 by operating the lever 33 to allow an initial portion of feed material onto the strip in the layer 12. Thus the strip is held onto the floor by the weight of the feed material and is properly located on the floor without creases, folding or slippage by the weight of the feed material as the feed material is deposited onto the strip as the vehicle is moved forwardly over the floor.

The strip is thus laid in long lengths along the length of the containment pen with the feed material spread evenly over the strip material for receiving the hatchlings 13.

In conventional manner, hatchlings can be carried manually and deposited carefully onto the feed material. The fact that the feed material is evenly spread allows the hatchlings to be dropped simply onto the paper at any position on the paper strip with the knowledge that the hatchling will be located on feed making it immediately accessible to the hatchling. Even the weakest hatchlings therefore can access feed immediately on becoming aware of their location allowing them to have access to the materials necessary for their growth thus reducing morbidity and loss.

a roll of biodegradable paper sheet for laying along the floor of a barn onto which the hatchlings are placed arranged for raising the chickens from the hatchlings to a larger size;

Turning now to FIGS. 3 and 4, there is shown an apparatus for raising chickens from hatchlings to a larger size including a barn 40 having a floor 42 covered by a layer 43 of straw or similar protective and absorbent material and walls 41 where the barn is closed for containing the hatchlings 45.

In the barn is provided a series of rows 46 of feed stations. The rows are arranged at spaced positions across the floor. Each row includes a feed supply line 47 connected along the row 46 for dispensing feed to each of the feed stations 48, 49. The feed stations are attached to the feed line 47 and the row of feed stations is connected to a lift system 50 for raising the feed stations from the floor to a raised position for cleaning of the floor and laying of paper while the floor is unencumbered by the feed line. There is also provided a series of rows of water supply stations 51 arranged at spaced positions across the floor and alternating with the feed lines. Each water supply row comprises a water supply line 54 connected along the row with a series of spaced water nipples 52 for dispensing water to each of the water supply stations. The row 51 of water supply stations is also connected to a lift system 53 for raising the water supply stations from the floor in a similar manner to the feed stations.

In this arrangement, the machine above is used to lay a first strip 55 of biodegradable paper sheet unrolled along the floor of the barn underneath the row of feed stations and a second strip 56 of biodegradable paper sheet unrolled along the floor of the barn underneath the row of water supply stations.

An additional strip can be laid between the rows of water and feed supply lines.

The biodegradable paper is colored with a color selected to be attractive to hatchlings. It is know that certain colors and particularly red or a color sufficiently close to red is suitable to provide attraction to the hatchlings. The specific color to be selected is any red color, but other suitable colors can be used which can be found to be more attractive to the hatchlings than the natural brown color of traditional paper or of white paper.

The row 46 of feed stations includes a plurality of feed supply dishes 48A at the stations 48 into which feed is deposited from the feed supply line and a plurality of feed drops 49A at the stations 49 where the feed is deposited directly onto the strip of paper. In this way in an initial feed supply process a feed supply member such as an auger in the line 47 is operated to drop feed both into the dishes and onto the paper. The hatchlings can take the feed from the paper until they are ready to feed from the dishes. The colored paper attracts the hatchlings to the feed line and to the water line so that they have access to the materials when otherwise they may not reach the materials and perish.

The feed drops 49 which are located intermediate the feed supply dishes 48A include a manually operable valve 49B which can be shut off when the hatchlings are old and mature enough to always access the feed in the dishes 48A.

The row of water supply stations or nipples 52 are arranged such that the water is deposited directly onto the strip of paper so that the hatchlings are attracted to the water supply again to reduce the possibility of their perishing through failure to move to the required location.

1. Apparatus for raising chickens from hatchlings to a larger size comprising:
a roll of biodegradable paper sheet for laying along the floor of a barn onto which the hatchlings are placed arranged for raising the chickens from the hatchlings to a larger size;
wherein the biodegradable paper is colored with a color selected to be attractive to hatchlings.

2. The apparatus according to claim 1 wherein the paper is colored red or a color sufficiently close to red to provide the attraction to the hatchlings.

3. Apparatus for raising chickens from hatchlings to a larger size comprising:
a barn having a floor and walls for containing the hatchlings;
a plurality of feed stations arranged at spaced positions across the floor;
a plurality of water dispensing stations arranged at spaced positions across the floor;
and a roll of biodegradable paper sheet unrolled along the floor of the barn onto which the hatchlings are placed arranged for raising the chickens from the hatchlings to a larger size;
wherein the biodegradable paper is colored with a color selected to be attractive to hatchlings.

4. The apparatus according to claim 3 wherein the paper is colored red or a color sufficiently close to red to provide the attraction to the hatchlings.

5. The apparatus according to claim 3 wherein the paper forms a strip located between the feed stations and the water supply stations which are arranged in parallel rows.

6. Apparatus for raising chickens from hatchlings to a larger size comprising:
a barn having a floor and walls for containing the hatchlings;
a row of feed stations arranged at spaced positions across the floor with a feed supply line connected along the row for dispensing feed to each of the feed stations;
the row of feed stations being connected to a lift system for raising the feed stations from the floor;
a row of water supply stations arranged at spaced positions across the floor with a water supply line connected along the row for dispensing water to each of the water supply stations;
the row of water supply stations being connected to a lift system for raising the water supply stations from the floor;
a first strip of biodegradable paper sheet unrolled along the floor of the barn underneath the row of feed stations;
and a second strip of biodegradable paper sheet unrolled along the floor of the barn underneath the row of water supply stations;
wherein the biodegradable paper is colored with a color selected to be attractive to hatchlings.

7. The apparatus according to claim 6 wherein the paper is colored red or a color sufficiently close to red to provide the attraction to the hatchlings.

8. The apparatus according to claim 6 wherein the row of feed stations includes a plurality of feed supply dishes into which feed is deposited from the feed supply line and a plurality of feed drops where the feed is deposited directly onto the strip of paper.

9. The apparatus according to claim 8 wherein the feed drops can be shut off when the hatchlings are old and mature enough to always access the feed in the dishes.

10. The apparatus according to claim 8 wherein the feed drops of the row of feed stations are located intermediate the feed supply dishes.

11. The apparatus according to claim 6 wherein the row of water supply stations are arranged such that the water is deposited directly onto the strip of paper.
